(19) United States
(12) Patent Application Publication
(10) Pub. No.: US 2009/0120092 A1
(43) Pub. Date: May 14, 2009

(54) SINGLE LOOP HEAT PUMP GENERATOR

(76) Inventor: Zhiguo Li, Tianjin (CN)

Correspondence Address: LACKENBACH SIEGEL, LLP, LACKENBACH SIEGEL BUILDING, 1 CHASE ROAD, SCARSDALE, NY, 10583, US

(21) Appl. No.: 12/298,271

(22) PCT Filed: Nov. 22, 2007
(86) PCT No.: PCT/CN2007/003311

§ 371 Date: Jan. 16, 2009

(30) Foreign Application Priority Data
Nov. 24, 2006 (CN) 200610102180.X

(51) Int. Cl. F01K 27/00; F25B 1/00; F03G 7/10

(52) U.S. Cl. 60/643; 62/498; 415/916

(57) ABSTRACT

A single loop heat pump generator includes a vaporizer in which a liquid working medium can gasify by unordered heat in the air and produce high-speed gas flow, a turbine generator unit for changing the kinetic energy of the high-speed gas flow into electric energy and a compressor for compressing the exhaust of a turbine into hot and compressed gas and transferring the hot and compressed gas to a liquefier, and the liquefier is connected with the vaporizer by a feed pipe of the liquid working medium. The generator has a closed loop, and it can output electric power.

### CROSS REFERENCE TO RELATED APPLICATIONS

This application relates to and claims priority from International Application No. PCT/SN2007/003311 filed Nov. 22, 2007, the contents of which are fully enclosed herein by reference; which further relates to and claims priority from Chinese App. No. 200610102180.X filed Nov. 24, 2006.

### BACKGROUND OF THE INVENTION

1. Field of the Invention

The present invention related to a heat pump power generating device. In particular, the present application relates to a single cycle heat pump power generating device.

2. Description of the Related Art

The related art involves traditional power generating devices taking part of the orderly energy (coal and oil) for use in electric power output, and the remaining part is used as the power for system operations, which eventually returns to the air in the form of heat radiation. Quite obviously, related art systems require conventional fuel, discharges harmful gases into the air and consume a large amount of energy. A heat pump power generating device uses heat in the air as its source of energy. After the system is operated, the surplus power is output. That is, the disorderly thermal energy (or unorderly kinetic energy) in the air (or water or other medium) is turned into orderly electric energy.

Chinese Patent 200410097600.0 discloses an energy-source technical solution that uses a heat pump and a dual fluid cycle power device, which uses two closed loop cycle systems, one of which is used to gather heat and the other of which is used to heat the machine. Therefore, the system efficiency in this related art is extremely low. At the same time, since the methyl propane and methyl butane used thereby are inflammable gases, it is not desirable to have any emission to the atmosphere.

### SUMMARY OF THE INVENTION

The purpose of the present invention is to provide a single cycle system which does not require a machine heating cycle. The system directly feeds heat to the evaporator for use. It is highly efficient, pollution free and is single cycle heat pump power generating device that can use a moderate and low temperature condensing refrigerant.

The technical solution for achieving the above purpose of the invention provides a single cycle heat pump power generating device, including: an evaporator that uses the disorderly or disperse thermal energy in the air as a source of energy to cause the liquid refrigerant in the evaporator to gasify and generate a high velocity air stream. A turbine generator unit that uses the aforementioned high velocity air stream and converts it to mechanical energy and thence into electric energy. The turbine generator includes a compressor that compresses the exhaust discharged by the turbine into a high temperature, high pressure gas and that transmits the high temperature, high pressure gas to a liquidifer. The aforementioned liquidifier is connected to the evaporator through a liquid refrigerant transmission pipeline.

Alternatively, the technical solution for achieving the above purpose of the invention can also be a single cycle heat pump power generating device, including: an evaporator that uses the disorderly thermal energy in the air as a source of energy to cause the liquid refrigerant in it to gasify and generate a high velocity air stream. A turbine generator unit that uses the aforementioned high velocity air stream and converts mechanical energy into electric energy, also includes: a compressor that compresses the exhaust discharged by the turbine into a high temperature, high pressure gas and that transmits the high temperature, high pressure gas to a liquidifer (adaptively known as a liquefier). The aforementioned liquidifier causes the aforementioned high temperature, high pressure gas to perform a heat exchange with the refrigerant inside the evaporator, thus forming a positive feedback structure and sends the normal temperature liquid refrigerant formed after the heat exchange to the evaporator through a pressure pump.

Compared with the traditional power generating devices, first, the present invention uses heat in the air as its source of energy. After the system is operated, the surplus power is output. That is, the disorderly thermal energy in the air is turned into orderly electric energy; it does not require conventional fuel such as coal and oil, etc. and does not discharge harmful gases into the air, thus greatly alleviating the energy crisis and atmospheric warming.

Compared with the conventionally known heat pump power generating device, the system in the present invention uses a closed loop cycle. Heat gathering and power generation use the same loop. In the device, the heat pump mechanism comprising of a liquidifier, an evaporator and a compressor play the role of an energy amplifier, driving the compressor with electric energy, compressing the refrigerant and releasing heat feedback to the liquidifier or evaporator. The refrigerant absorbs the heat and becomes gasified, thus driving the turbine and causing the generator to generate power. Part of the power generated is again supplied for use by the compressor. Since theoretically, by providing 1 KW of electric energy, 5 KW of heat can be obtained (at the current efficiency), whereas through the generator, about 3˜3.8 KW of electric power may be obtained. Therefore, no external power supply is required. As long as electric power is fed back, the heat pump will operate under self excitation. In addition, after the power consumption required for system operations is taken into consideration, there is still surplus power that can be output to outside the system for work.

The above, and other features and advantages of the present invention will become apparent from the following description read in conjunction with the accompanying drawings, in which like reference numerals designate the same elements.

### BRIEF DESCRIPTION OF THE DRAWINGS

FIG. 1 is a framework drawing of the single cycle heat pump power generating system in the present invention.

FIG. 2 is a structural schematic of the single cycle heat pump power generating system without heat exchange in the present invention.

FIG. 3 is a framework drawing of the positive feedback single cycle heat pump power generating system in the present invention.

FIG. 4 is a schematic of the internal exchange, positive feedback single cycle heat pump power generating system in the present invention.

FIG. 5 is a schematic of the external exchange, positive feedback single cycle heat pump power generating system in the present invention.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

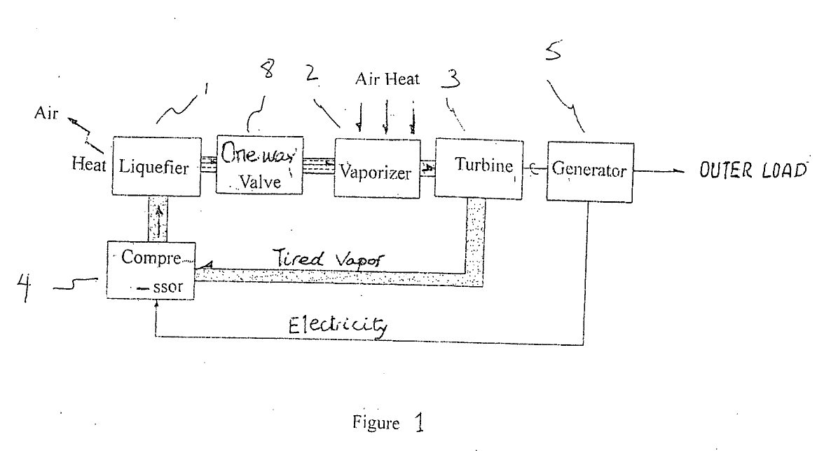

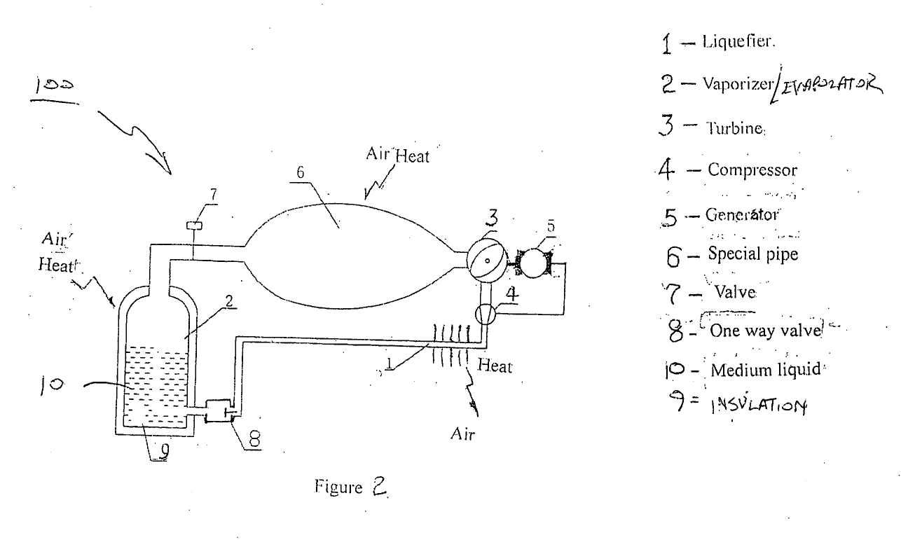

As shown in FIG. 2, a first embodiment 100 is a single cycle heat pump power generating system without heat exchange given in the system framework picture shown in FIG. 1 (as shown operatively in FIG. 2). It comprises a liquidifier 1, an evaporator 2, a compressor 3, a turbine 4, a generator 5, an irregular tube 6 shown with an enhanced volume relative to an inlet and outlet for pressure reduction and acceleration, an airtight valve 7 and a throttle one way valve 8. Evaporator 2 is a container with a bucket structure, with an insulation layer 9 added to its outside and containing a liquid refrigerant 10 inside and having a gas chamber and a high pressure gas outlet. Its high pressure gas outlet is connected to the irregular pipe 6 for pressure reduction and acceleration through a pipe and the airtight valve 7 installed thereon. The high velocity air stream outlet of said irregular pipe 6 for pressure reduction and acceleration is connected to turbine 4. The power outlet axis of turbine 4 is connected to generator 5. Its exhaust gas outlet is connected to compressor 3. The high temperature, high pressure gas outlet of compressor 3 is connected to liquidifier 1 (or alternatively liquefier). Liquidifier 1 can be a spiral pipe or a pipe with a radiator. Its normal temperature liquid refrigerant outlet is connected to evaporator 2 (or a vaporizer 2) through a pipe and throttle 8 installed thereon. Generator 5 is connected to compressor 3 through a transmission line, as shown.

The work process of the single cycle heat pump power generating system without heat exchange 100, is as follows:

During operation, there is an opening of airtight valve 7 and a use of an external power supply to drive compressor 3 and form a negative pressure at the exhaust gas outlet of turbine 4. Then, liquid refrigerant 10 inside evaporator 2 absorbs heat in the air and becomes evaporated, forming high pressure gas, which is transmitted through a pipe and enters irregular pipe 6 for pressure reduction and acceleration. It then rushes into heating chamber, where it forms a high velocity air stream after its pressure is reduced and after it is accelerated. It then rushes into turbine 4, which drives it to rotate and drive generator 5 to operate and generate power. The exhaust gas is compressed by compressor 3 into a high pressure, high temperature gas refrigerant. It then enters liquidifier 1, where its heat is radiated, thus forming a normal temperature, liquid refrigerant. The refrigerant enters evaporator 2 through throttle 8, absorbs heat in the air and becomes evaporated again, and the above steps are repeated. In addition to being used by the system itself, the electric power generated by generator 5 still has surplus power to be output outside the system.

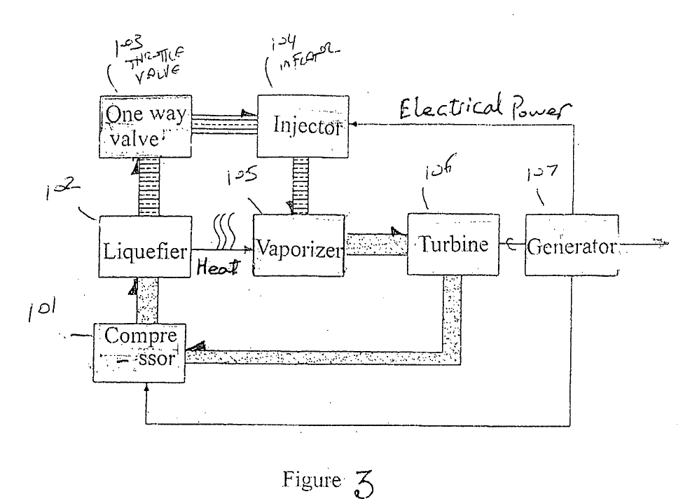

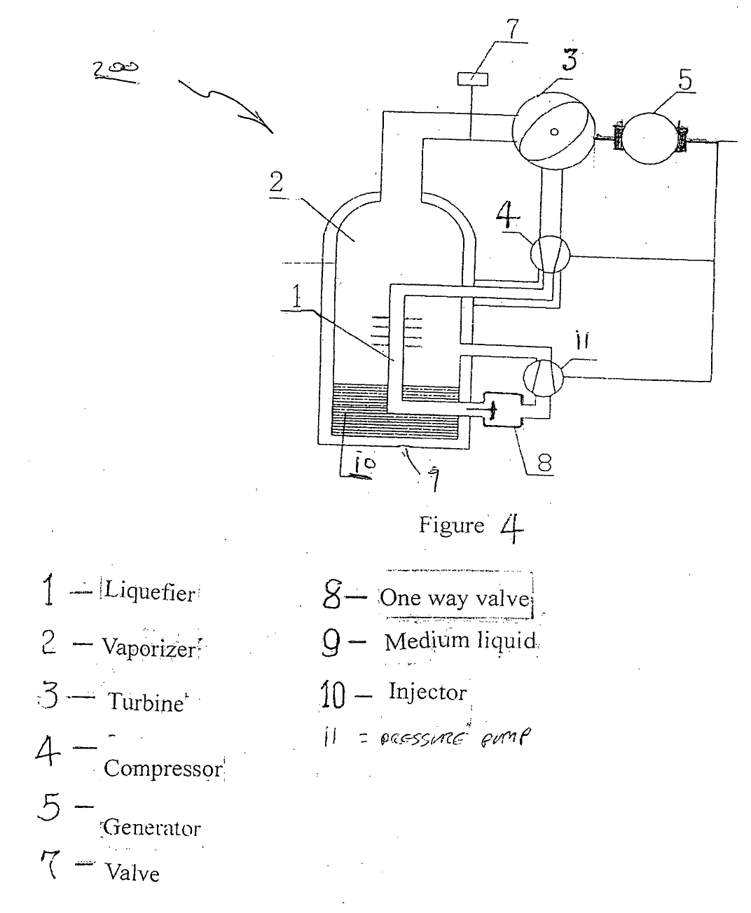

A second embodiment noted at 200 is an internal exchange, positive feedback single cycle heat pump power generating system given based on the system framework drawing in FIG. 3 (as shown in FIG. 4). It comprises a liquidifier 1, an evaporator 2, a compressor 4, a turbine 3, a generator 5, an airtight valve 7, a throttle 8 and a pressure pump 11. The evaporator 2 is a container with a bucket structure, with an insulation layer 9 added to its outside and containing a liquid refrigerant 10 inside and having a gas chamber and a high pressure gas outlet. Its air stream outlet is connected to turbine 4 through a pipe and airtight valve 7 installed therein. The power outlet axis of turbine 4 is connected to generator 5. Its exhaust gas outlet is connected to compressor 3. The high temperature, high pressure gas outlet of compressor 3 is connected to liquidifier 1. Liquidifier 1 and evaporator 2 form a heat exchanger. Liquidifer 1 can be a spiral pipe or a pipe with a radiator. Its main body is placed inside liquid refrigerant 10 of evaporator 2. The normal temperature liquid refrigerant outlet is connected to evaporator 2 through a pipe and throttle 8 and pressure pump 11 installed thereon. Generator 5 is electrically connected to compressor 3 and pressure pump 11 through a transmission line.

The work process of an internal exchange, positive feedback single cycle heat pump power generating system 200 is as follows:

Liquid refrigerant 10 in evaporator 2 continuously absorbs external heat. It is evaporated into a gaseous refrigerant and gathers in the gas chamber in the upper part of evaporator 2. Open airtight valve 7 and use external power supply to start compressor 3. Form a negative pressure at the outlet of turbine 4. The gaseous refrigerant in evaporator 2 rushes into turbine 4 through a connecting pipe and drives it to rotate and drives generator 5. The exhaust gas discharged from turbine 4 is compressed into liquidifier 1 by compressor 3. The input end of liquidifier 1 is a high temperature, high pressure refrigerant gas, which is continuously reduced in temperature along its main body of the spiral pipe. The output end becomes a liquid refrigerant slightly higher than the normal pressure, which is then injected into evaporator 2 after being subjected to pressure by pressure pump 2 that is higher than that of evaporator 2. Since liquidifier 1 feeds heat back to evaporator 2, causing the temperature of the refrigerant gas in evaporator 2 to exceed the ambient temperature by several dozen degrees, the pressure reaches or exceeds 45 ATM. Then, the gas rushes into turbine 4 through a connecting pipe. Repeat the above steps. In addition to being used by the system itself, the electric power generated by generator 5 still has surplus power to be output outside the system.

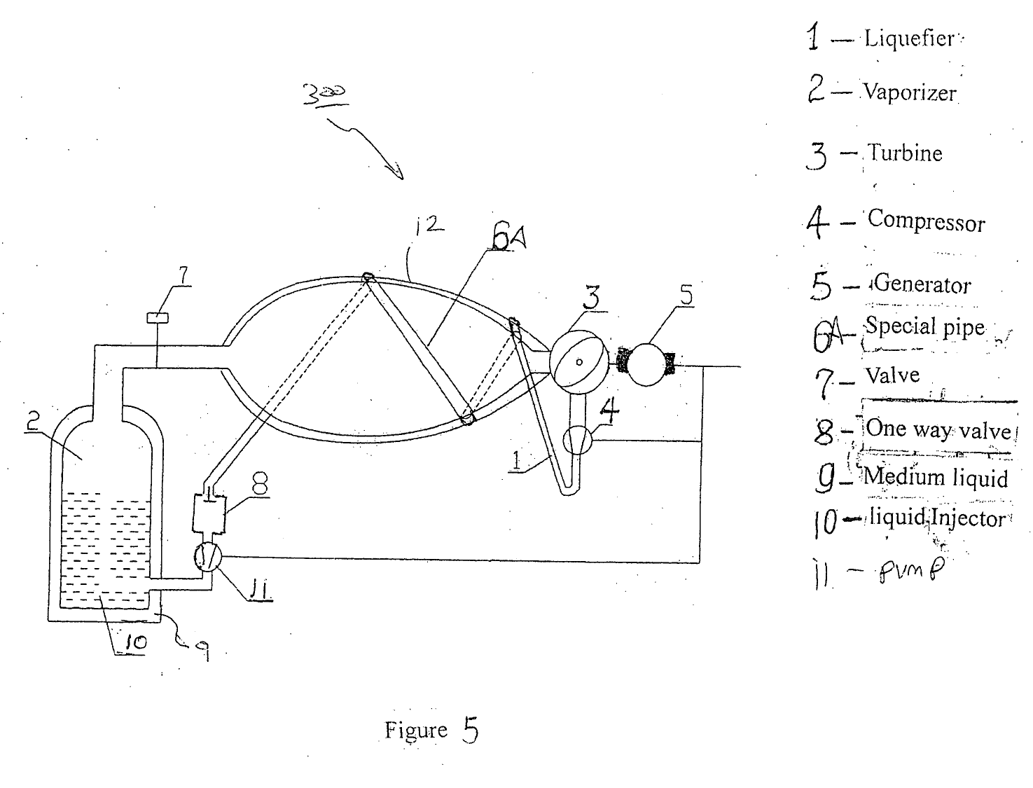

Embodiment 300 is an external exchange, positive feedback single cycle heat pump power generating system given based on the system framework drawing in FIG. 3 (as shown in FIG. 5). The difference from embodiment 100 is that in addition to having liquidifier 1, evaporator 2, compressor 3, turbine 4, generator 5, airtight valve 7, throttle 8 and pressure pump 11, it also has a heating chamber 12. Said heating chamber 12 is an irregular pipe in structure, with one end being connected to the outlet of evaporator 2 through a pipe and the other end being connected to turbine 4. The main body portion of liquidifier 1 winds around the exterior of the housing of said heating chamber 12 as a coil pipe 6A, forming a heat exchanger with heating chamber 12. The normal temperature liquid refrigerant outlet of liquidifier 1 is connected to evaporator 2 through a pipe and throttle 8 and pressure pump 11 installed thereon.

The work process of an external exchange, positive feedback single cycle heat pump power generating system 300 is as follows:

Open airtight valve 7 and use external power supply to start compressor 3. Form a negative pressure at the outlet of turbine 4. The gaseous refrigerant in evaporator 2 rushes into turbine 4 through a connecting pipe, where the air stream has its pressure reduced and velocity accelerated. It is sprayed from the tail pipe of heating chamber 12 and drives turbine 4, which in turn drives generator 5 to generate power. the exhaust gas is compressed into a high pressure, high temperature gaseous refrigerant by compressor 3 and enters liquidifier 1, where it transfers heat to the gaseous refrigerant in heating chamber 12 in the form of a coil pipe, so that the temperature of the gaseous refrigerant flowing into heating chamber 12 from evaporator 2 rises, thus causing the velocity of the air stream sprayed from the tail of heating chamber 12 to be higher and thus causing the turbine generator unit to generate more power. At the same time, this part of the high pressure, high temperature gaseous refrigerant loses heat due to a heat exchange, forming a liquid normal temperature refrigerant. Then throttle 8 and pressure pump 11 send the gaseous refrigerant into evaporator 2, where it absorbs atmospheric thermal energy, becomes evaporated and the above steps are repeated. In addition to supplying pressure pump 4 and compressor 3, the electric power generated still has surplus power to be output outside the system.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

1.-5. (canceled)

6. A single cycle heat pump generator device, comprising:
an evaporator that uses the disorderly thermal energy in the air as a source of energy to cause the liquid refrigerant in it to gasify and generate a high velocity air stream;
a turbine generator unit that uses the aforementioned high velocity air stream and converts mechanical energy into electric energy;
said turbine generator unit being characterized in that it further comprises:
a compressor that compresses the exhaust discharged by the turbine into a high temperature, high pressure gas;
whereby said high temperature, high pressure gas is transmitted to a liquidifer; and
said liquefier being in operative communication with the evaporator through a liquid refrigerant transmission pipeline.

7. A single cycle heat pump generator device, according to claim 6, further comprising:
an evaporator, a compressor, and an irregular pipe for pressure reduction and acceleration, each in operative flow communication with an airtight valve and a throttle;
said evaporator being a container having a bucket structure with an insulation layer added to its outside and containing a liquid refrigerant therein and having a gas chamber and a high pressure gas outlet;
said high pressure gas outlet connected to the irregular pipe for pressure reduction and acceleration through a pipe and the airtight valve installed thereon;
said high velocity air stream outlet of said irregular pipe for pressure reduction and acceleration being connected to the turbine; and
wherein the power outlet axis of the turbine is connected to the generator, the generator exhaust gas outlet is connected to the compressor, the high temperature and high pressure gas outlet of the compressor is connected to the liquidifier.

8. A single cycle heat pump generator device, according to claim 7, wherein:
the liquidifier can be one of a spiral pipe and a pipe with a radiator;
whereby its normal temperature liquid refrigerant outlet is connected to the evaporator through a pipe and the throttle installed thereon and the generator is connected to the compressor through a transmission line.

9. A single cycle heat pump generator device, comprising:
an evaporator that uses the disorderly thermal energy in the air as a source of energy to cause the liquid refrigerant in it to gasify and generate a high velocity air stream;
a turbine generator unit that uses the aforementioned high velocity air stream and converts mechanical energy into electric energy,
said turbine generator unit being characterized in that it further comprises:
a compressor that compresses the exhaust discharged by the turbine into a high temperature, high pressure gas and that transmits the high temperature, high pressure gas to a liquidifer; and
whereby the liquidifier performs a heat exchange with the refrigerant inside the evaporator, thus forming a positive feedback structure and sends the normal temperature liquid refrigerant formed after the heat exchange to the evaporator through a pressure pump.

10. A single cycle heat pump generator device, according to claim 9, further comprising:
a compressor, a liquidifier, a pressure pump, a throttle and an airtight valve, and further comprises in operative flow connection, an irregular pipe for pressure reduction and acceleration, an airtight valve and a throttle;
said evaporator being a container with a bucket structure and with an insulation layer added to its outside and containing a liquid refrigerant inside and having a gas chamber and a high pressure gas outlet;
whereby its high velocity air stream outlet is connected to the turbine through a pipe and the airtight valve installed therein;
whereby the power outlet axis of the turbine is connected to the generator, and its exhaust gas outlet is connected to the compressor;
whereby the high temperature, high pressure gas outlet of the compressor is connected to the liquidifier;
whereby the liquidifier and the evaporator form a heat exchanger;
whereby the liquidifer can be one of a spiral pipe and a pipe with a radiator and it's main body being placed inside the liquid refrigerant of the evaporator;
whereby the normal temperature liquid refrigerant outlet is connected to the evaporator through a pipe and the throttle and pressure pump installed thereon; and
whereby the generator is connected to the compressor and pressure pump through a transmission line.

11. A single cycle heat pump generator device, according to claim 9, further comprising:
a compressor, a liquidifier, a pressure pump, a throttle and an airtight valve, and further comprises:
a heating chamber;
said heating chamber having an irregular pipe structure with one end being connected to the outlet of the evaporator through a pipe and the airtight valve installed thereon and the other end being connected to the turbine;
a main body portion of the liquidifier winding around the exterior of said heating chamber housing as a coil pipe, forming a heat exchanger with the heating chamber, and
whereby the normal temperature liquid refrigerant outlet is connected to the evaporator through a pipe and the throttle and pressure pump installed thereon.
